(19) United States
(12) Patent Application Publication
(10) Pub. No.: US 2014/0339171 A1
(43) Pub. Date: Nov. 20, 2014

(54) EQUIPMENT AND METHOD FOR WATER AND STREAM PURIFICATION USING PRE-TREATMENT AND MULTI-LAYERED MEDIA SYSTEM

(71) Applicant: KOREA INSTITUTE OF SCIENCE AND TECHNOLOGY, Seoul (KR)

(72) Inventors: Kyu Hong AHN, Seoul (KR); Ki Pal KIM, Seoul (KR); Tae Un JEONG, Seoul (KR); Duk Soo JANG, Seoul (KR)

(21) Appl. No.: 13/945,251

(22) Filed: Jul. 18, 2013

(30) Foreign Application Priority Data
May 16, 2013 (KR) 10-2013-0055551

(51) Int. Cl. C02F 1/00; C02F 1/28; C02F 1/72

(52) U.S. Cl. CPC C02F 1/004; C02F 1/72; C02F 1/283
USPC 210/668; 210/170.1

(57) ABSTRACT

The present disclosure relates to equipment and method for water and stream purification using a pre-treatment and multi-layered media system which may effectively remove dissolved phosphorus, COD and organic matter by introducing a pre-treatment device to stably operate filter media and applying a strainer to each filter media to improve water permeating ability of the filter media.

### CROSS-REFERENCE TO RELATED APPLICATION

This application claims priority to Korean Patent Application No. 10-2013-0055551, filed on May 16, 2013, and all the benefits accruing therefrom under 35 U.S.C. §119, the contents of which in its entirety are herein incorporated by reference.

### BACKGROUND

1. Field

The present disclosure relates to equipment and method for water and stream purification using a pre-treatment and multi-layered media system, and more particularly, to equipment and method for water and stream purification using a pre-treatment and multi-layered media system which may effectively remove dissolved phosphorus, chemical oxygen demand (COD) and organic matter by introducing a pre-treatment device to stably operate filter media and applying a strainer to each filter media to improve water permeating ability of the filter media.

2. Description of the Related Art

General river maintenance business has caused river straight strengthening and damaged river environments, which reduces stay time of river streams and loses self purification capacity. Meanwhile, in view of river pollution, due to large water quantity and low pollutant concentration, it is not practical to apply a water treatment process to the entire river. Therefore, the demand on environment-friendly water purification techniques is gradually increasing to recover the self purification capacity of the river and maintain clean water quality.

Water purification techniques using contact oxidation facilities, artificial wetlands, artificial floating islands or the like, applied against this backdrop, have advantages in excellent biological removal efficiency due to vegetation and microorganism and improve surrounding sceneries. However, at floods, such water purification techniques may not keep their functions or their structures may collapse. To overcome such limits, it is needed to develop an environment-friendly water purification method capable of taking a basin area including surface water, underground water and land into consideration and a device capable of selectively removing substances causing turbidity or eutrophication by such as suspended solid (SS) of river contamination sources, dissolved phosphorus or the like.

In this viewpoint, Korean Patent Registration No. 586496 discloses ‘a double-current purification device for treating stream water, lake water and effluent water of wastewater treatment equipment, and a purification method using the same’, in which a double-current stabilization is constructed at the terrace land on the river or the site of a lake side to dissolve organic matters by means of soil filtration, adsorption and microorganism metabolism and plants are set out to remove nitrogen and phosphorus for the purpose of improving water quality. However, in this method, since the treatment quantity absolutely depends on a permeability coefficient of soil deposits, a sufficient treatment capacity is not easily ensured if a soil having not bad permeability is used. In addition, a clogging phenomenon occurs in case of long-term operation, which makes it difficult to maintain the operation.

In order to solve this problem, a multi-stage soil deposit method has been developed and used. The multi-stage soil deposit method is disclosed in Japanese Unexamined Patent Publication No. 2004-154696, Korean Unexamined Patent Publication No. 2011-0048244 or the like. In the multi-stage soil deposit method, basically, the flow of fluid is changed based on a purification method using soils. In detail, soils are blocked into a predetermined pattern, soil deposits are piled up on a target area and a reaction chamber in a brickwork pattern, and a permeable layer is formed between soil deposits to improve water discharge capacity. In this method, it is possible to enhance the treatment amount by improving the water discharge capacity of the permeable layer. However, since stream water mostly penetrates through the permeable layer, the amount of water permeating into the soil deposits which play an important role in the treatment of stream water relatively decreases. In particular, it is difficult to remove dissolved phosphorus which may cause eutrophication of the river, and a relatively large site area is demanded due to a low filtration rate.

### RELATED LITERATURES

### Patent Literature

Patent Literature 1: Korean Patent Registration No. 586496
Patent Literature 2: Japanese Unexamined Patent Publication No. 2004-154696
Patent Literature 3: Korean Unexamined Patent Publication No. 2011-0048244

### SUMMARY

The present disclosure is directed to providing equipment and method for water and stream purification using a pre-treatment and multi-layered media system which may effectively remove dissolved phosphorus, chemical oxygen demand (COD) and organic matter by introducing a pre-treatment device to stably operate filter media and applying a strainer to each filter media to improve water permeating ability of the filter media.

In one aspect, there is provided equipment for water and stream purification using a pre-treatment and multi-layered media system, which includes multi-layered filter media stacked in order in a vertical direction, wherein the multi-layered filter media are disposed to be spaced apart from each other in the vertical direction, wherein a filter media separator is closely adhered to a lower portion of each filter media, wherein a plurality of filtered water supply holes are formed in the filter media separator, wherein a strainer is coupled to each of the filtered water supply holes, and wherein a filtered water redistribution plate for dispersing filtered water is provided to a lower portion of the strainer.

The strainer may include a filter provided on the filter media separator and a screwing unit screwed with the filtered water supply hole of the filter media separator, the filter of the strainer may be embedded in the filter media, filtered water having passed through the filter media may flow into an inner space of the strainer through an opening of the filter, and the filtered water having moved along the inner space of the strainer may be dropped and dispersed onto the filtered water redistribution plate and supplied to the next filter media.

The equipment may further include a pre-treatment device, wherein the pre-treatment device may include a filter cloth and diatomite provided on the filter cloth, and wherein suspended solid may be removed when the stream water passes through diatomite of the pre-treatment device, and the stream water free from suspended solid may be supplied onto the multi-layered filter media.

The multi-layered filter media may include a third filter media, a second filter media and a first filter media stacked in order from the bottom, wherein the first filter media may remove chemical oxygen demand (COD) in the stream water to lower a COD concentration, the second filter media may remove organic matter and dissolved contaminants contained in the stream water, and the third filter media may remove dissolved phosphorus in the stream water.

The first filter media may be made of slag, the second filter media may be made of any one of activated carbon, modified activated carbon and their mixtures, and the third filter media may be made of oxidation-coated porous filter material. In addition, the equipment may further include a non-woven fabric provided at the upper portion of the multi-layered filter media, wherein the non-woven fabric may play a role of filtering off suspended solid contained in the stream water.

A water collecting pipe for collecting water treated by the multi-layered filter media may be provided at a lower portion of the lowermost filter media, and the water collecting pipe may be connected to the river. The equipment may further include a stream water distributing pipe provided on a front surface of the multi-layered filter media, wherein the stream water distributing pipe may be disposed in a lattice pattern on the front surface of the multi-layered filter media. In addition, the multi-layered filter media may be divided into a plurality of regions, and the stream water supplied to each region through the stream water distributing pipe may be selectively supplied or blocked.

In another aspect, there is provided a method for water and stream purification using a pre-treatment and multi-layered media system, which is performed in equipment including a third filter media, a second filter media and a first filter media stacked in order in a vertical direction to be spaced apart from each other, wherein a filter media separator is closely adhered to a lower portion of each filter media, wherein a plurality of filtered water supply holes are formed in the filter media separator, wherein a strainer is coupled to each of the filtered water supply holes, wherein a filtered water redistribution plate for dispersing filtered water is provided to a lower portion of the strainer, and wherein method includes: removing organic matter of stream water by the first filter media; removing COD of the stream water by the second filter media; removing dissolved phosphorus by the third filter media; and discharging the water treated through the third filter media to the river via a water collecting pipe, wherein the filtered water having passed through each filter media flows into an inner space of the strainer, and the filtered water having moved along the inner space of the strainer is dropped and dispersed onto the filtered water redistribution plate and supplied to the next filter media.

The equipment and method for water and stream purification using a pre-treatment and multi-layered media system according to the present disclosure give the following effects.

Suspended solid, organic matter, COD and dissolved phosphorus in the stream water may be effectively removed using the pre-treatment device and the multi-layered filter media. In particular, since filtered water is uniformly distributed to the next filter media through a strainer and a filtered water redistribution plate provided at the lower portion of each filter media, the purification efficiency of stream water may be maximized.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a diagram showing equipment for water and stream purification using a pre-treatment and multi-layered media system;

FIG. 2 shows a displacement of a stream water distributing pipe; and

FIGS. 3 to 5 are diagrams showing filter media.

[Detailed Description of Main Elements]

| | |
|---|---|
| 110: pre-treatment device | 111: filter cloth |
| 112: diatomite | 120: stream water recycling facility |
| 130: stream water distributing pipe | 140: water collecting pipe |
| 150: non-woven fabric | 210: first filter media |
| 220: second filter media | 230: third filter media |
| 310: filter media separator | 311: stream water supply hole |
| 320: strainer | 321: filter |
| 322: screwing unit | |
| 331: filtered water redistribution | 332: connection unit |
| plate | |

### DETAILED DESCRIPTION

The present disclosure may remove suspended solid, organic matter, COD and dissolved phosphorus contained in a stream using multi-layered filter media, and particularly maximize filtration efficiency of stream water by uniformly distributing the filtered water passing through each filter media to the next filter media through a strainer and a filtered water redistribution plate provided at the lower portion of each filter media. In addition, a pre-treatment device using diatomite is provided at the front end of the multi-layered filter media so that suspended solid in the stream water may be effectively removed. Hereinafter, equipment and method for water and stream purification using a pre-treatment and multi-layered media system according to an embodiment of the present disclosure will be described in detail with reference to the drawings.

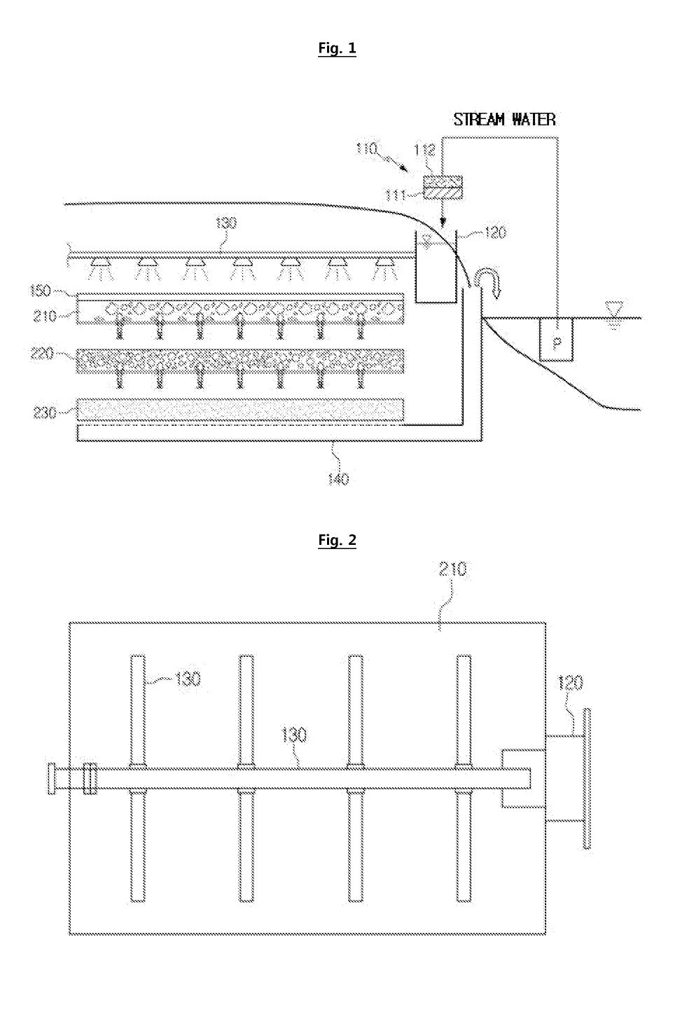

Referring to FIG. 1, the equipment for water and stream purification using a pre-treatment and multi-layered media system according to an embodiment of the present disclosure includes a pre-treatment device 110 and multi-layered filter media.

The pre-treatment device 110 removes suspended solid in the stream water before the stream water is supplied to the multi-layered filter media and may be configured by providing diatomite 112 in a powder state on a filter cloth 111. The diatomite 112 plays a role of filtering off suspended solid contained in the stream water, and the stream water free from suspended solid passes through the filter cloth 111 and is stored in a stream water recycling facility 120.

The stream water stored in the stream water recycling facility 120 is uniformly distributed and supplied onto the multi-layered filter media through a stream water distributing pipe 130. In order to uniformly supply the stream water onto the multi-layered filter media, the stream water distributing pipe 130 is disposed in a lattice pattern on the front surface of the multi-layered filter media (see FIG. 2). In addition, the stream water supplied through the stream water distributing pipe 130 may be selectively controlled according to locations of the multi-layered filter media. For example, the filter media may be divided into a plurality of regions, and the stream water may be selectively supplied to each region so that the equipment is controlled to operate or halt.

The multi-layered filter media play a role of purifying the stream water supplied through the stream water distributing pipe 130. In detail, the multi-layered filter media play a role of removing organic matter, COD and dissolved phosphorus contained in the stream water in order by means of filtration, adsorption and ion exchange. The multi-layered filter media may be composed of at least three filter media, and each filter media may be configured to perform a specific function (for example, removing organic matter, removing COD, or removing dissolved phosphorus). Hereinafter, the multi-layered filter media will be described as including three filter media, for example.

The multi-layered filter media may include a first filter media 210, a second filter media 220 and a third filter media 230. The third filter media 230, the second filter media 220 and the first filter media 210 are stacked in order and disposed to be spaced apart from each other. The filter media are disposed to be spaced apart from each other in order to prevent filter materials of the filter media from mixing and allow filtered water having passed through a filter media (for example, the first filter media 210) located above to be uniformly supplied to a filter media (for example, the second filter media 220) located below.

The first to third filter media 210 to 230 play different functions from each other. In detail, the first filter media 210 plays a role of lowering a COD concentration by removing COD in the stream water, the second filter media 220 plays a role of removing organic matter and dissolved contaminants contained in the stream water, and the third filter media 230 plays a role of removing dissolved phosphorus in the stream water. As described above, the first to third filter media 210 to 230 perform different functions from each other, and for this, the first filter media 210 may be made of slag, the second filter media 220 may be made of any one of activated carbon, modified activated carbon and their mixtures, and the third filter media 230 may be made of oxidation-coated porous filter material.

Meanwhile, uniformly supplying the filtered water having passed through an upper filter media to a lower filter media gives a direct influence on filtration efficiency of the stream water, namely purification efficiency. Therefore, the present disclosure additionally proposes a strainer 320 and a filtered water redistribution plate 331 in addition to the stream water distributing pipe 130 and the filter media spaced apart from each other, for the purpose of uniform supply of filtered water. In other words, in the present disclosure, for uniform supply of the stream water and filtered water, 1) the stream water distributing pipe 130, 2) the filter media spaced apart from each other, and 3) the strainer 320 and the filtered water redistribution plate 331 are applied. The stream water may be uniformly distributed onto the first filter media 210 through the stream water distributing pipe 130. However, in this case, the stream water may not be uniformly distributed onto the second filter media 220 and the third filter media 230 disposed below it. By disposing the filter media to be spaced apart from each other, the filtered water may be uniformly supplied to some extent, but this has a limit due to internal features of the filter media. By providing the strainer 320 and the filtered water redistribution plate 331 at the lower end of each filter media as a final means for uniformly supplying the filtered water, it is possible to complete uniform supply of the filtered water. The strainer 320 and the filtered water redistribution plate 331 may not be provided at the filter media disposed at the lowermost side.

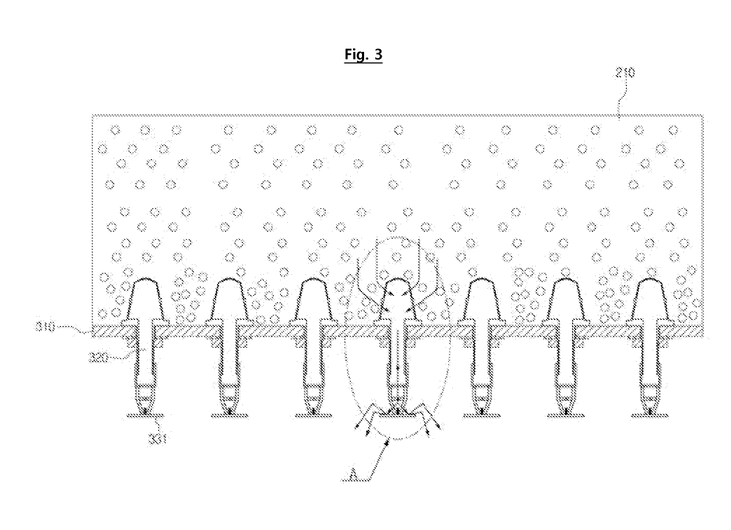

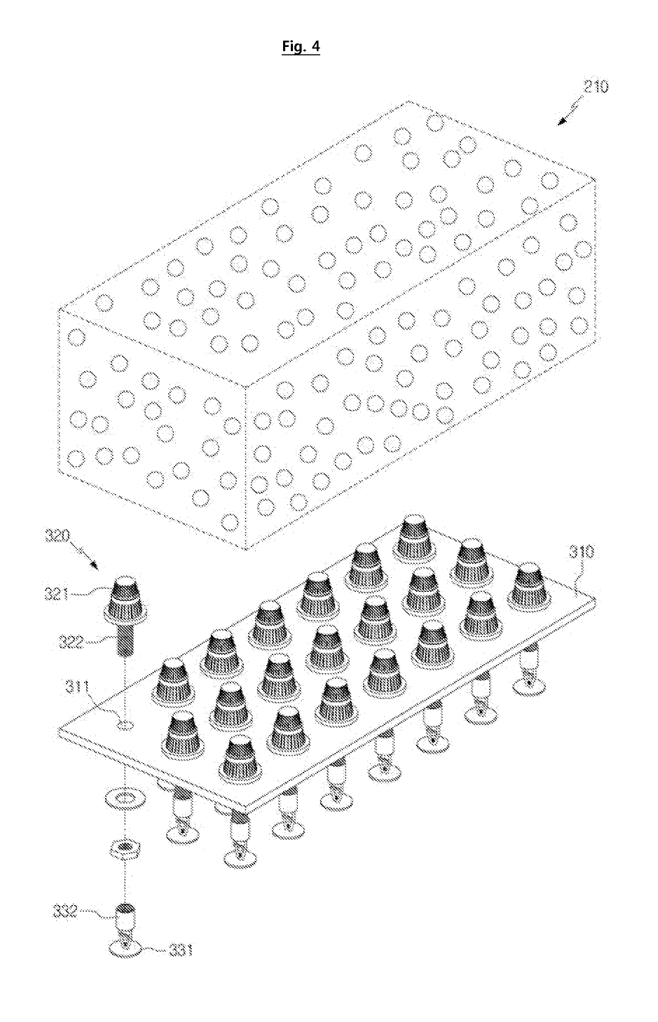

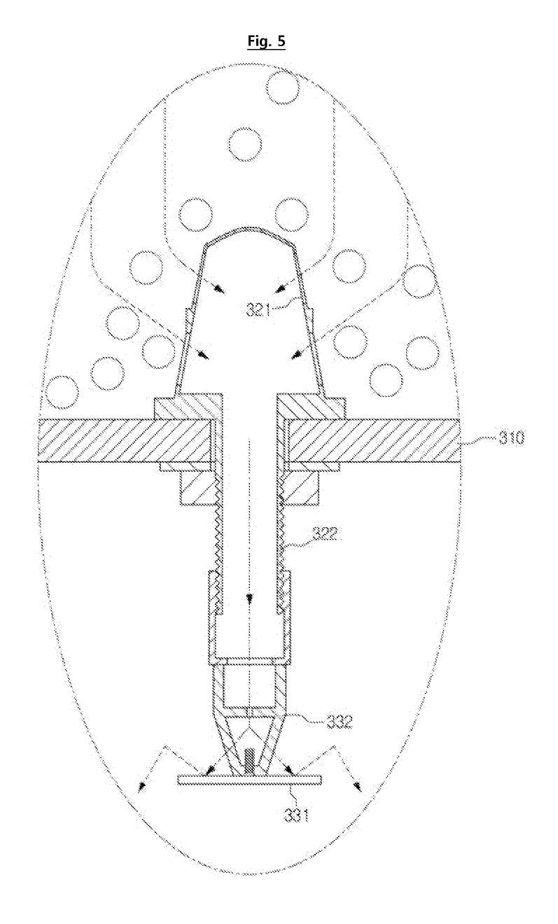

As shown in FIGS. 3 to 5, the strainer 320 and the filtered water redistribution plate 331 are integrally coupled, and the strainer 320 is mounted to a filter media separator 310. The filter media separator 310 is closely adhered to the lower portion of each filter media, and a plurality of strainers 320 are disposed at the filter media separator 310 at regular intervals.

The strainer 320 is a kind of filter which filters the stream water passing through the filter media once more. The strainer 320 includes a cone-shaped filter 321, and an opening of a predetermined size is formed in the filter 321. The filtered water passing through the opening of the filter 321 is moved downwards through an internal passage of the strainer 320. Meanwhile, the strainer 320 may be screwed with the filter media separator 310. In other words, a screwing unit 322 is provided at the lower portion of the filter 321, and the screwing unit 322 is screwed with a filtered water supply hole of the filter media separator 310. The inside of the filter 321 and the screwing unit 322 of the strainer 320 is empty and plays a role of a passage of the filtered water.

Since the filter media separator 310 is closely adhered to the lower portion of the filter media, the cone-shaped filter 321 of the strainer 320 is embedded in the filter media. Since the filter 321 of the strainer 320 is embedded in the filter media as described above, the filtered water passing through the filter media may flow into the filter 321 of the strainer 320.

The filtered water redistribution plate 331 is integrally connected to the strainer 320, and the filtered water redistribution plate 331 may also be screwed with the strainer 320. In other words, a connection unit 332 provided at one side of the filtered water redistribution plate 331 may be screwed with the screwing unit 322 of the strainer 320. And, the inside of the connection unit 332 is also empty, similar to the screwing unit 322, and accordingly the filtered water flowing through the inside of the screwing unit 322 is moved through the connection unit 332 and finally drops onto the upper portion of the filtered water redistribution plate 331.

The filtered water having moved along the inner space of the strainer 320 drops and is distributed onto the filtered water redistribution plate 331, and the filtered water distributed by the filtered water redistribution plate 331 is uniformly distributed and supplied onto the next filter media. Since a plurality of strainers 320 is provided at the filter media separator 310, the filtered water redistribution plate 331 is provided at the lower portion of each strainer 320, and the filtered water is dispersed by each filtered water redistribution plate 331, the filtered water may be uniformly distributed to each filter media close to a theoretical value. Meanwhile, the filter media separator 310, the strainer 320 and the filtered water redistribution plate 331 may not be provided at the lower portion of the lowermost filter media, for example the third filter media 230, as described above.

In addition to the above, a non-woven fabric 150 may be provided on the first filter media 210 in order to remove suspended solid contained in the stream water. Since suspended solid in the stream water is filtered off by the non-woven fabric 150, it is possible to prevent the multi-layered filter media from being closed by suspended solid or the like, and total suspended solid (SS) of the stream water may be lowered.

Meanwhile, the amount of stream water treated by the multi-layered filter media may be selectively controlled by adjusting a contact time between the filter media and the stream water. If the contact time between the multi-layered filter media and the stream water is set to be short, the removal rate of contaminants is lowered and the amount of treated stream water increases. If the contact time is set to be long on the contrary, the removal rate of contaminants increases and the amount of treated stream water decreases. The filtration rate of the multi-layered filter media may be controlled to be 5 m/hr or below in consideration of the amount of treated stream water. In addition, the multi-layered filter media may be designed to have a height of 1 to 3 m in consideration of an underground water level, a stream water level and a regime coefficient, and each filter media may have a height of 20 to 60 cm.

In addition, a water collecting pipe 140 for collecting water treated by the multi-layered filter media is provided at the lower portion of the third filter media 230, and the finally treated water is discharged to the river through the water collecting pipe 140.

While the exemplary embodiments have been shown and described, it will be understood by those skilled in the art that various changes and equivalents may be made thereto without departing from the spirit and scope of the present disclosure.

What is claimed is:

1. Equipment for water and stream purification using a pre-treatment and multi-layered media system, comprising:
multi-layered filter media stacked in order in a vertical direction,
wherein the multi-layered filter media are disposed to be spaced apart from each other in the vertical direction,
wherein a filter media separator is closely adhered to a lower portion of each filter media,
wherein a plurality of filtered water supply holes are formed in the filter media separator,
wherein a strainer is coupled to each of the filtered water supply holes, and
wherein a filtered water redistribution plate for dispersing filtered water is provided to a lower portion of the strainer.

2. The equipment for water and stream purification using a pre-treatment and multi-layered media system according to claim 1,
wherein the strainer includes a filter provided on the filter media separator and a screwing unit screwed with the filtered water supply hole of the filter media separator, and
wherein the filter of the strainer is embedded in the filter media, filtered water having passed through the filter media flows into an inner space of the strainer through an opening of the filter, and the filtered water having moved along the inner space of the strainer is dropped and dispersed onto the filtered water redistribution plate and supplied to the next filter media.

3. The equipment for water and stream purification using a pre-treatment and multi-layered media system according to claim 1, further comprising a pre-treatment device,
wherein the pre-treatment device includes a filter cloth and diatomite provided on the filter cloth, and
wherein suspended solid is removed when the stream water passes through diatomite of the pre-treatment device, and the stream water free from suspended solid is supplied onto the multi-layered filter media.

4. The equipment for water and stream purification using a pre-treatment and multi-layered media system according to claim 1,
wherein the multi-layered filter media include a third filter media, a second filter media and a first filter media stacked in order from the bottom, and
wherein the first filter media removes chemical oxygen demand (COD) in the stream water to lower a COD concentration, the second filter media removes organic matter and dissolved contaminants contained in the stream water, and the third filter media removes dissolved phosphorus in the stream water.

5. The equipment for water and stream purification using a pre-treatment and multi-layered media system according to claim 4,
wherein the first filter media is made of slag, the second filter media is made of any one of activated carbon, modified activated carbon and their mixtures, and the third filter media is made of oxidation-coated porous filter material.

6. The equipment for water and stream purification using a pre-treatment and multi-layered media system according to claim 1, further comprising a non-woven fabric provided at the upper portion of the multi-layered filter media,
wherein the non-woven fabric plays a role of filtering off suspended solid contained in the stream water.

7. The equipment for water and stream purification using a pre-treatment and multi-layered media system according to claim 1,
wherein a water collecting pipe for collecting water treated by the multi-layered filter media is provided at a lower portion of the lowermost filter media, and the water collecting pipe is connected to the river.

8. The equipment for water and stream purification using a pre-treatment and multi-layered media system according to claim 1, further comprising a stream water distributing pipe provided on a front surface of the multi-layered filter media,
wherein the stream water distributing pipe is disposed in a lattice pattern on the front surface of the multi-layered filter media.

9. The equipment for water and stream purification using a pre-treatment and multi-layered media system according to claim 8,
wherein the multi-layered filter media are divided into a plurality of regions, and the stream water supplied to each region through the stream water distributing pipe is selectively supplied or blocked.

10. A method for water and stream purification using a pre-treatment and multi-layered media system, which is performed in equipment including a third filter media, a second filter media and a first filter media stacked in order in a vertical direction to be spaced apart from each other,
wherein a filter media separator is closely adhered to a lower portion of each filter media,
wherein a plurality of filtered water supply holes are formed in the filter media separator,
wherein a strainer is coupled to each of the filtered water supply holes,
wherein a filtered water redistribution plate for dispersing filtered water is provided to a lower portion of the strainer, and
wherein method comprises:
removing organic matter of stream water by the first filter media;
removing COD of the stream water by the second filter media;
removing dissolved phosphorus by the third filter media; and
discharging the water treated through the third filter media to the river via a water collecting pipe,
wherein the filtered water having passed through each filter media flows into an inner space of the strainer, and the filtered water having moved along the inner space of the strainer is dropped and dispersed onto the filtered water redistribution plate and supplied to the next filter media.
